(19) United States
(12) Patent Application Publication
(10) Pub. No.: US 2013/0322220 A1
(43) Pub. Date: Dec. 5, 2013

(54) SYSTEM FOR STABILIZING OPTICAL TAPE DURING READ/WRITE OPERATIONS IN OPTICAL TAPE DRIVE

(71) Applicants: Daniel Underkofler, Lafayette, CO (US); Steven Suttle, Broomfield, CO (US)

(72) Inventors: Daniel Underkofler, Lafayette, CO (US); Steven Suttle, Broomfield, CO (US)

(73) Assignee: ORACLE INTERNATIONAL CORPORATION, Redwood City, CA (US)

(21) Appl. No.: 13/484,840

(22) Filed: May 31, 2012

(51) Int. Cl. G11B 11/00; G11B 33/02

(52) U.S. Cl. 369/13.05; 369/75.11; G9B/11; G9B/33.002

(57) ABSTRACT

A system for stabilizing optical tape passing in front of one or more optical pickup units (OPUs) in an optical tape drive. The system includes at least one stabilizing apparatus having a pair of stabilizing members (e.g., partially convex members placed proximate each other) located opposite at least one OPU along the path of a length of optical tape. Each stabilizing member has a support portion (e.g., crown) over which the optical tape passes as the tape is being written to or read by the OPU. The support portion of one stabilizing member is spaced from the support portion of the other stabilizing member by a depression or recess over which the optical tape passes as it moves between the first and second support members. The OPU may direct laser beams at a relatively short, planar span of unsupported optical tape over the depression as part of read/write operations.

### BACKGROUND

1. Field of the Invention

The present invention generally relates to optical tape drives and, more particularly, to a stabilizing system that serves to reduce optical tape run-out and other focusing issues as optical tape passes in front of one or more optical pickup units (OPUs) in an optical tape drive.

2. Relevant Background

Optical tape is a type of digital storage media that is generally in the form of a long, thin and narrow strip of polymer that is designed to wind between two reels and be moved in first and second opposite longitudinal directions by drive motors (the reels and drive motors being known as a “tape transport system”) of an optical tape drive. As the optical tape is moved between the reels by the drive motor, digital content (e.g., binary data in the form of a series of encoding patterns) may be written and read by one or more lasers which may be embodied in one or more optical pickup units (OPUs). The encoded binary data may be in the form of “marks” (e.g., indentations, indicia) and “spaces” (e.g., the portion of the tape between adjacent pits) disposed on one or more encoding or recording layers (e.g., each including a dye recording layer, a phase change material such as AgInSbTe, and/or a semi transparent metal reflecting layer). Generally, the smaller the indicia are on the optical media, the higher the capacity is of the optical media.

For enhanced performance, the optical tape drive typically needs to provide substantially precise positioning and planarizing of a span of optical tape as it moves in front of each of the one or more OPUs to facilitate accurate focusing and tracking operations of the objective lens of each OPU. Planarizing generally refers to the notion of maintaining the read/write surface of the optical tape substantially planar as it passes in front of each of the one or more OPUs so that lasers emitted by the OPUs are substantially perpendicular to the optical tape surface during the read/write operations. Some previous attempts at planarizing and stabilizing optical tape as it passes in front of an OPU (e.g., in relation to the focusing or z-axis of the OPU) have included use of a single substantially smooth, at least partially cylindrical hydrodynamic bump guide at least partially around which the optical tape is wrapped and over which the optical tape moves as it passes in front of the OPU. Specifically, a crown (e.g., top portion) of the bump is designed to position the tape to be substantially perpendicular to the OPU laser just as the tape passes in front of the OPU.

### SUMMARY

Optical tape stabilizers such as the above-discussed single cylindrical hydrodynamic guides present a number of problems that can affect focusing operations, read/write operations, and the like. For instance, debris (e.g., dust, powder, particles, and the like) resident on the crown of the stabilizer and/or on the underside of the tape (i.e., the surface of the tape facing the stabilizer as it passes over the stabilizer) can lead to “tenting” of the tape (i.e., bulging or lifting of discrete portions of the tape) and result in focusing and/or data integrity issues. As another example, substantial quantities of both time and effort must be expended to ensure that the surface finish of such cylindrical hydrodynamic guides is highly smooth to avoid the situation where any texturing on the guide “prints” through to the tape leading to corruption of the laser signals from the OPU. Also, machining or otherwise forming such guides to be highly smooth often results in high levels of stiction (e.g., “jo-blocking”) that must be overcome to move the tape relative to the guide which can damage or otherwise negatively affect the tape. Still further, placement tolerances between an OPU and its respective cylindrical hydrodynamic guide are relatively tight as the OPU's laser needs to be precisely aligned with the crown of the cylindrical guide.

In view of the foregoing, disclosed herein are apparatuses, systems, methods, and the like for stabilizing optical tape as it passes in front of each of one or more OPUs in an optical tape drive that serve to alleviate at least the above-discussed issues present with previous or current stabilizing devices. Specifically, at least one pair of stabilizing “bumps” (e.g., partially cylindrical or at least convex members placed proximate each other) may be located opposite at least one OPU and within the tape path of a length of optical tape. Each bump has a support portion (e.g., crown) over which a length of optical tape passes as the tape moves through the tape drive. The support portion of one bump is spaced apart from the support portion of the other bump by a depression or recess over which the tape passes along the tape path as it moves from the first support portion to the second support portion. In this regard, a substantially planar span of unsupported optical tape (i.e., a span not directly supported underneath by one of the bumps) is created between the two support portions, where the span is substantially perpendicular to laser signals of the at least one OPU. The at least one OPU may perform read/write operations on the optical tape over the unsupported substantially planar span (i.e., on the portion of optical tape between the bumps).

The disclosed embodiments present a number of advantages over previous stabilizing designs for optical tape drives. In one regard, placement tolerances of the OPU lasers along the tape path are relaxed as the lasers need merely be aligned with the tape somewhere over the unsupported planar span between the two support portions as opposed to needing to be precisely aligned with the crown of one of the bumps, such as with the single cylindrical guides of previous stabilizing systems. In another regard, tolerances associated with the surface finish of the bumps may also be relaxed as concerns regarding any texturing on the bumps printing through to the tape during OPU read/write operations are eliminated or at least reduced (i.e., because the OPU reads from/writes to the unsupported span where such texture printing would not occur anyway). Added benefits of relaxed surface finish tolerances of the bumps are a reduction in the stiction necessary to allow relative motion between the tape and the bumps as well as a reduction in surface finishing costs.

Furthermore, the likelihood of tenting due to debris resident on the surface of one of the bumps is eliminated or at least reduced as OPU laser beams may be directed at the unsupported span instead of at the crown of one of the bumps. Furthermore, the likelihood of tenting due to debris resident on the underside of the tape is also eliminated or at least reduced as there would not be a surface (e.g., like the crown of the previous cylindrical guide) to support such debris and urge it into the tape during read/write operations of the OPU due to the provision of the gap/depression between the crowns of the bumps.

In one aspect, a tape drive includes a housing, at least a first OPU secured within the housing and configured to emit at least one laser beam along a first axis for use in performing reading and/or writing operations on optical tape moved in front of the first OPU, and at least a first stabilizing apparatus secured within the housing and spaced from the first OPU. The first stabilizing apparatus includes first and second stabilizing members having support portions configured to abuttingly support the optical tape as the optical tape is being moved in front of the first OPU. The first and second support portions are spaced apart by a recess along a tape path of the optical tape as the optical tape moves over the support portions of the first and second stabilizing members. The first OPU is configured to perform reading and/or writing operations on the optical tape as the optical tape travels over the recess such that the first axis intersects the optical tape between the first and second support portions.

In another aspect, a method of operating an optical tape drive includes moving optical tape along a tape path over first and second support portions of at least a first stabilizing apparatus of the tape drive, where the first stabilizing apparatus includes a depression between the first and second support portions over which the optical tape passes as the optical tape moves along the tape path between the first and second support portions. The method also includes emitting, using at least a first OPU of the tape drive, one or more laser beams onto the optical tape over the depression between the first and second support portions.

In a further aspect, a device for use in stabilizing optical tape along a focus axis of at least one optical pickup unit (OPU) of an optical tape drive includes a base member that is configured to be secured to a housing of the optical tape drive and a plurality of stabilizing apparatuses secured to a common surface of the base member. Each stabilizing apparatus includes first and second stabilizing members having support portions configured to abuttingly support the optical tape as it is being moved within the tape drive and separated by a depression over which the optical tape passes as the optical tape travels along the tape path.

Any of the embodiments, arrangements, or the like discussed herein may be used (either alone or in combination with other embodiments, arrangement, or the like) with any of the disclosed aspects. Merely introducing a feature in accordance with commonly accepted antecedent basis practice does not limit the corresponding feature to the singular. Any failure to use phrases such as “at least one” does not limit the corresponding feature to the singular. Use of the phrase “at least generally,” “at least partially,” “substantially” or the like in relation to a particular feature encompasses the corresponding characteristic and insubstantial variations thereof. Furthermore, a reference of a feature in conjunction with the phrase “in one embodiment” does not limit the use of the feature to a single embodiment.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a perspective view of a portion of an optical tape drive including a stabilizing device according to one embodiment.

FIG. 2 is a plan view of the optical tape drive of FIG. 1.

FIG. 3 is another perspective view of the optical tape drive of FIG. 1.

FIG. 4 is a close-up plan view of FIG. 2 and showing the positioning a stabilizing apparatus of the stabilizing device relative to one or more OPUs.

FIG. 5 is a close-up plan view of FIG. 2 and showing the positioning between a plurality of the stabilizing apparatuses of the stabilizing device relative to a plurality of OPUs.

FIG. 6 is a perspective view of the stabilizing device of the optical tape drive of FIG. 1.

### DETAILED DESCRIPTION

Disclosed herein are apparatuses, systems, methods, and the like useful for stabilizing optical tape relative to a focus axis of a number of OPUs as the optical tape passes in front of the same in an optical tape drive. At least one stabilizing apparatus made up of a pair of stabilizing members (e.g., partially cylindrical or convex members or bumps placed proximate each other) is configured to be positioned or spaced opposite at least one OPU in a tape drive and along the tape path of a length of optical tape. Each stabilizing member has a support portion (e.g., crown) over which the optical tape passes as the tape is being written to or read by the at least one OPU. The support portion of one stabilizing member is spaced from the support portion of the other stabilizing member by a gap or depression over which the optical tape passes as it moves between the first and second support members. The at least one OPU may direct laser beams along one or more axes at a relatively short, planar span of unsupported optical tape over the depression as part of read/write operations. Advantages include relaxed placement tolerances of OPUs relative to optical tape and surface finish tolerances of the stabilizing members, decreased instances and/or degrees of tenting due to debris disposed on an underside of the optical tape and/or on the support portions of the stabilizing members, and the like.

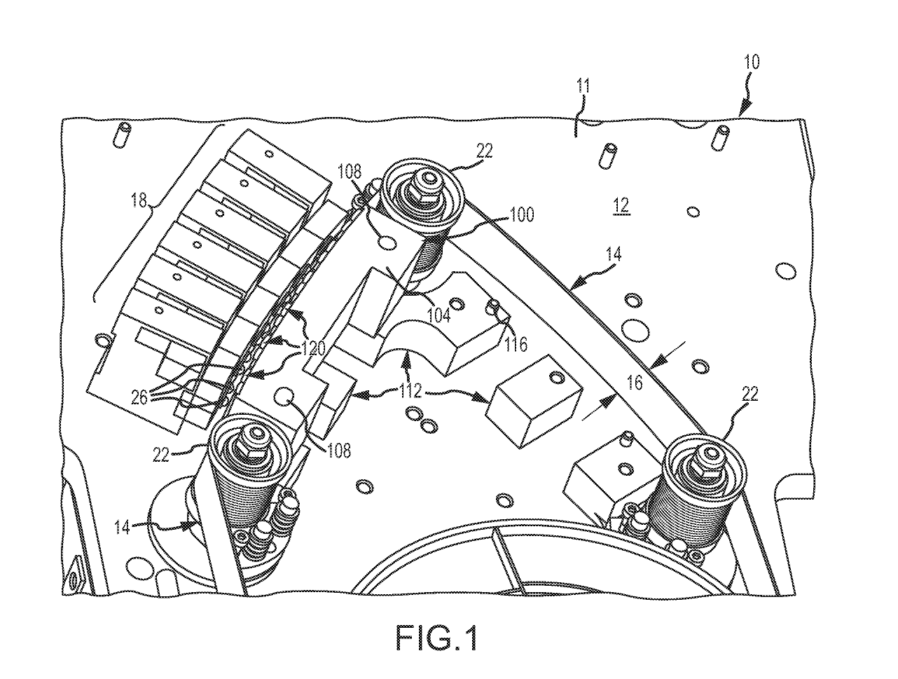

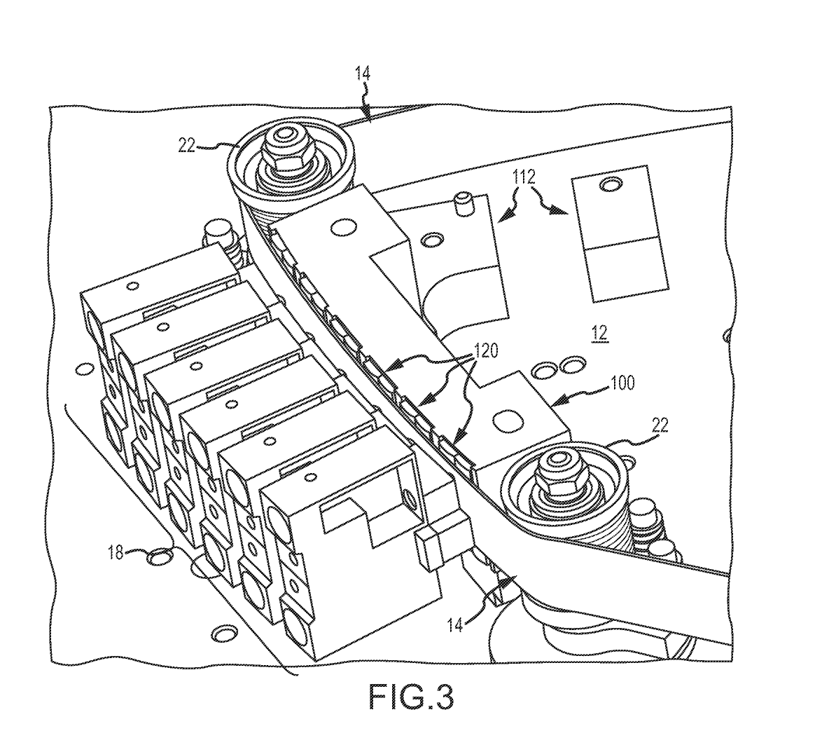

With reference to FIGS. 1-3, a portion of an optical tape drive 10 that is operable to move a length of optical tape 14 (e.g., optical tape media) in first and second opposing directions along a tape path to allow one or more OPUs 18 to perform read/write operations on the optical tape 14 is shown. The tape drive 10 generally includes a housing 11 and one or more supply and take-up reels (not shown) for the optical tape 14 that are appropriately configured to be driven by one or more drive motors (not shown). The tape drive 10 also includes a plurality of guide rollers 22 that are arranged and configured to guide the optical tape 14 in front of the one or more OPUs 18 as the one or more drive motors rotate the supply and takeup reels to move the optical tape 14 in the first or second opposing directions. While not shown, the optical tape drive 10 also includes a number of other components such as controllers, amplifiers, memory, and/or other mechanisms.

Each OPU 18 may include an optical system of a known type for generating at least one radiation or laser beam guided through one or more optical elements (e.g., one or more lens units 26) focused to one or more radiation spots or areas on an information recording layer (e.g., including a dye recording layer and/or a semi transparent metal reflecting layer) of the optical tape 14. Typically, the radiation beam projects through a surface of the optical tape 14 and may be generated by a radiation source (e.g., laser diode). While not shown, each OPU 18 may also include one or more detectors (e.g., photodetectors, photodiodes) which may receive light reflected from the optical tape 14 and may produce readout signals indicative of data written on the optical tape 14 as well as servo signals (e.g., error signals). Additionally, each OPU 18 may further include any number of well known actuators for moving/focusing a laser beam emanating from the OPU 18 in any appropriate manners. For instance, each OPU 18 may include a servo system and/or tracking actuator which serve to change a lateral position of the OPU 18 relative to the optical tape 14. As another example, each OPU 18 may include a focusing actuator for adjusting the focus of the radiation beam along the optical axis of the laser beams.

As discussed previously, it is often desirable to stabilize the optical tape 14 in relation to each of the one or more OPUs 18 as the optical tape 14 is moving in front of the OPUs 18 during reading and/or writing operations. For instance, it is typically advantageous to stabilize the optical tape 14 against movement along a focusing or optical axis of the laser beams of the OPUs 18 to facilitate more precise focusing and tracking operations of the OPUs 18. Previous attempts to achieve such stabilization have included use of a single convex stabilizing bump spaced opposite each particular OPU, where the single convex bump has a crown partially around which the optical tape is wrapped and over which the optical tape moves (where the optical tape is spaced from the bump by a thin hydro-dynamic air film) during reading/writing operations of the OPU. However, such previous stabilization attempts can result in tenting of the optical tape (e.g., due to debris resident on the surface of the bump over which the tape travels and/or on the underside of the tape), high tolerances associated with having to precisely align the optical axis of the laser beam with the crown of the stabilizing bump as well as achieving a substantially smooth surface finish of the bump (e.g., to avoid printing through of any texturing on the bump onto the tape), and the like.

In this regard, disclosed herein is a stabilizing system for use in stabilizing optical tape (e.g., optical tape 14) against movement along the focusing axes of one or more OPUs of an optical tape drive that alleviates one or more of the above-discussed drawbacks with previous optical tape stabilization devices and methods. As shown in FIGS. 1-3, the optical tape drive 10 may include one or more stabilizing apparatuses 120, where each stabilizing apparatus 120 is adapted to be spaced across from one or more OPUs 18 and configured to create a substantially planar and “unsupported” portion of the optical tape 14 (discussed in more detail below) onto and/or into which laser beams of the one or more OPUs 18 may be directed. For instance, the one or more stabilizing apparatuses 120 may be disposed between two of the guide rollers 22 and/or form part of one or more stabilizing devices 100 (only one shown in the Figures), where each stabilizing device 100 generally includes a body 104 that may be appropriately secured to the housing 11 of the optical tape drive 10 and where the one or more stabilizing apparatuses 120 may be secured or otherwise form part of the body 104. For instance, the body 104 may include a number of apertures 108 through which fasteners (not shown) may be appropriately received to secure the body 104 and thus the stabilizing device 100 to the housing 11 so as to be generally non-movable relative to the housing 11.

In one arrangement, the stabilizing device 100 may be spaced from a floor 12 of the housing 11 by one or more spacer members 112 (e.g., blocks, brackets, and/or the like) if necessary to align the stabilizing device 100 with the tape path of the optical tape 14. For instance, such spacer members 112 may be appropriately secured to the floor 12 of the housing 11 such as via adhesives, fasteners, etc. The stabilizing device 100 may be appropriately secured over and to the spacer members 112 in any appropriate manner (e.g., via fasteners extending through the apertures 108 of the stabilizing device 100 and into corresponding apertures of the spacer members 112). In one variation, the spacer members 112 (and/or stabilizing device 100) may include one or more pins 116 which are adapted to be received by respective apertures (e.g., apertures 108 or other apertures) on the stabilizing device 100 (and/or spacer members 112) to allow for quickly and efficiently aligning the stabilizing device 100 with the tape path of the optical tape 14.

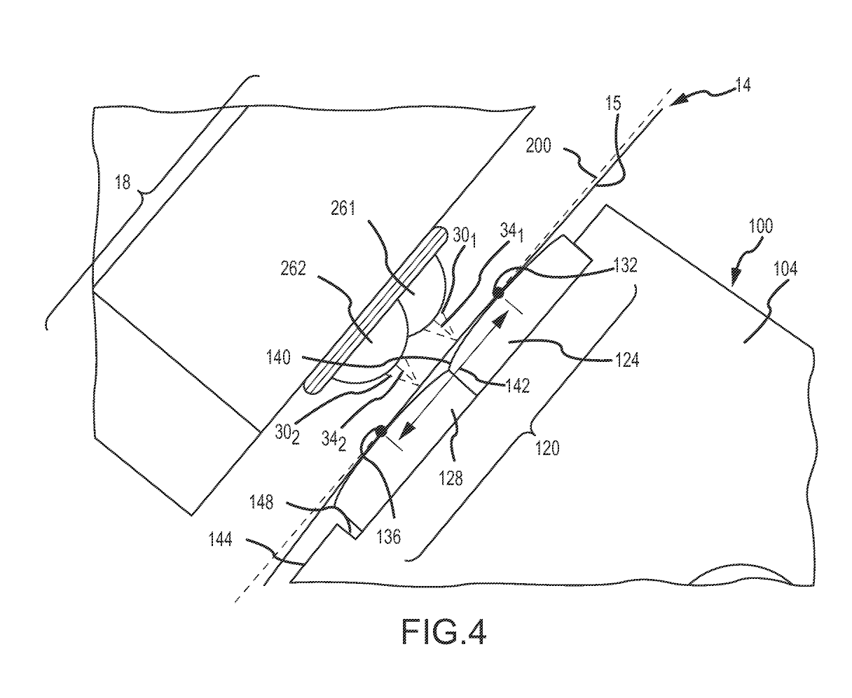

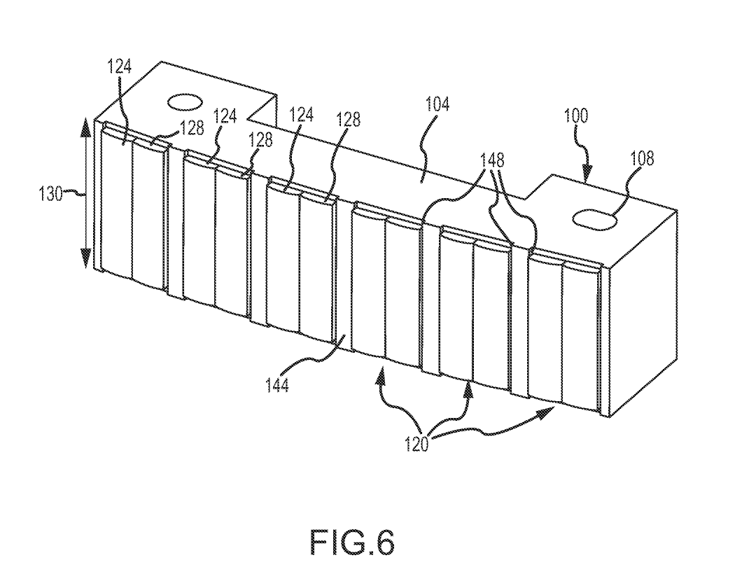

Turning now to FIGS. 4-6, each stabilizing apparatus 120 may include first and second stabilizing members 124, 128 (e.g., bumps, guides, back supports) each being constructed of any appropriate materials (e.g., wear resistant materials such as ceramic, stainless steel, nickel plating, and/or the like) and each being at least generally or substantially convex (e.g., shaped as a portion of a cylinder) in a direction generally towards one or more OPUs 18 (e.g., towards the one or more lens units 26 of the OPUs 18). Each of the first and second stabilizing members 124, 128 may have a length 130 that is at least substantially as great as or greater than a width 16 of the optical tape 14 (see width 16 in FIG. 1) so that at least substantially the entire width 16 of the underside 15 of the optical tape 14 may travel over the first and second stabilizing members 124, 128 as the optical tape 14 moves along the tape path.

As shown, the first and second stabilizing members 124, 128 of each stabilizing apparatus 120 may have respective first and second support portions 132, 136 (e.g., such as a crown or top portion of each of the first and second stabilizing members 124, 128) over which the optical tape 14 may move and which “abuttingly” support the underside 15 of the optical tape 14 in a direction generally perpendicular to the underside 15 of the optical tape 14. As used herein, the term “abuttingly” and variations thereof (e.g., abut, abuts, and the like) indicates that the underside 15 of the optical tape 14 is either in direct contact with each of the first and second support portions 132, 136 or closely faces but is separated from each of the first and second support portions 132, 136 by a thin hydrodynamic air film created between the underside 15 and each of the first and second support portions 132, 136 during movement of the optical tape 14 relative to the stabilizing apparatus 120 through the tape drive 10 (e.g., during read/write operations). The dots representing the first and second support portions 132, 136 in FIG. 4 are merely intended to indicate respective points or locations on the first and second stabilizing members 124, 128 (e.g., as opposed to small, spherical protrusions or the like). In one arrangement, the optical tape 14 may be at least partially wrapped over and/or around the first and second support portions 132, 136 (e.g., partially wrapped around a circumference of the first and second stabilizing members) as the optical tape 14 moves along the tape path (e.g., due to the convex nature of the first and second stabilizing members 124, 128 relative to the underside 15 of the optical tape 14).

Each stabilizing apparatus 120 also includes at least one depression 140 (e.g., gap, indent, recess, hollow, and/or the like) disposed between the first and second support portions 132, 136 that renders a span of the optical tape 14 unsupported in a direction generally perpendicular to the underside 15 of the optical tape 14 as the optical tape 14 moves along the tape path through the optical tape drive 10. That is, while substantially any span or portion of the optical tape 14 over the first and second support portions 132, 136 during movement of the optical tape 14 during reading/writing operations is substantially directly supported by the first and second support portions 132, 136 (e.g., in directions perpendicular to the underside 15), the optical tape 14 is substantially unsupported as the optical tape 14 moves over the depression 140 between the first and second support portions 132, 136. Stated still a different way, any span or section of optical tape 14 over the depression during movement of the optical tape 14 along the tape path during read/writing operations may be substantially free of an abutting relationship with the first and second stabilizing members 124, 128 (i.e., in addition to any other stabilizing members or the like). As an example, and merely for purposes of assisting the reader in understanding the disclosed stabilizing device 100, the thickness of the hydrodynamic air films between the underside 15 of the optical tape 14 and each of the first and second support portions 132, 136 may be on the order of at least a couple (e.g., 2-5) microns; the thickness of the depression 140 as measured from the underside 15 of the optical tape 14 to the bottom of the depression 140 may be on the order of at least about a hundred or couple hundred microns; and the distance 142 between the first and second support portions 132, 136 (and thus the length of the optical tape 14 between the first and second support portions 132, 136) may be on the order of at least about 0.05 inches, such as at least about 0.10 inches or at least about 0.15 inches. In one arrangement, the distance 142 between the first and second support portions 132, 136 may be no more than about 0.45 inches, such as no more than about 0.40 inches, or no more than about 0.35 inches (e.g., so as to reduce fluttering of the optical tape 14 between the first and second support portions 132, 136.

The depression 140 between the first and second support portions 132, 136 may be formed in numerous manners. In one arrangement and as shown, the depression 140 may be formed by virtue of locating the first and second convex stabilizing members 124, 128 adjacent each other which naturally forms the depression 140 between the first and second support portions 132, 136. In another arrangement, the first and second stabilizing members 124, 128 may be spaced from each other (e.g., in a direction along the tape path) where the space between the first and second stabilizing members 124, 128 at least partially forms the depression 140. In a further arrangement, each stabilizing apparatus 120 may be of a single or one-piece construction, where the single piece is appropriately formed to create the first and second support portions 132, 136 and the depression 140 therebetween. Furthermore, while the depression 140 is illustrated as gradually increasing in thickness from each of the first and second support portions 132, 136 to the bottom thereof, other arrangements envision that the depression 140 could have a substantially constant thickness between the first and second support portions 132, 136.

In any event, the span of optical tape 14 over the depression 140 and between the first and second support portions 132, 136 at substantially any time during movement of the optical tape 14 along the tape path during read/write operations may generally reside in a plane 200. That is, the first and second support portions 132, 136 may be appropriately spaced from each other so that even though the span of optical tape 14 over the depression 140 is unsupported, it may still be generally planar. As a result, lasers beams from one or more OPUs 18 can advantageously be directed onto or into almost any portion of the span of optical tape 14 between the first and second support portions 132, 136 and over the depression 140 for use in reading/writing operations as opposed to necessarily at a location directly over one of the first and/or second support portions 132, 136 (e.g., like the use of previous single bump arrangements).

For instance, first and second lens units 26₁, 26₂ of one or more OPUs 18 may be configured to focus first and second laser beams 30₁, 30₂ (e.g., as part of reading and/or writing operations) onto respective locations on the optical tape 14 between the first and second support portions 132, 136 and over the depression 140 as the optical tape 14 moves along the tape path through the optical tape drive 10 (e.g., such as along first and second focusing or optical axes 34₁, 34₂ that are generally perpendicular to the plane 200). That is, the first and second axes 34₁, 34₂ may substantially perpendicularly intersect the optical tape 14 over the depression 140. As the planar portion or length of optical tape 14 between the first and second support portions 132, 136 may be relatively large (e.g., one or more tenths of a inch) relative to the planar portion of the optical tape 14 directly over one of the support portions 132, 136 (e.g., one or more thousands of an inch or less, the latter being similar to the previous single bump arrangements), designers and manufacturers may have increased flexibility (and a corresponding relaxation in tolerances) associated with positioning one or more OPUs 18 (e.g., their lens units 26) relative to the optical tape 14 or vice versa. For instance, an OPU 18 and its respective stabilizing apparatus can be positioned relative to each other such that the laser beams 30 can be focused almost anywhere on the planar span of optical tape 14 between the first and second support portions 132, 136.

In addition to the above-discussed relaxed positioning tolerances, the first and second stabilizing members 124, 128 of each of the disclosed stabilizing apparatuses 120 can have relaxed surface finish tolerances as any risk of printing of surface texturing of the first and second stabilizing members 124, 128 through to the optical tape 14 during read/write operations is at least substantially nonexistent as the laser beams 30 are directed into or onto the supported span of optical tape 14 between the first and second support portions 132, 136 as opposed to directly over one or both of the first and second support portions 132, 136). For instance, the first and second stabilizing members 124, 128 may in some embodiments have an intentionally rougher surface to increase manufacturability of the members. Furthermore, allowing for an intentionally rougher surface finish of the members 124, 128 reduces the amount of stiction that needs to be overcome to allow for relative movement between the optical tape 14 and the members. Still further, any risk of tenting of the optical tape 14 and the negative effects on focusing and the like of the one or more OPUs 18 can also be substantially eliminated as any debris (e.g., dust, particles, and/or the like) would not have a surface (e.g., such as the first or second support portions 132, 136) serving to press such debris into the underside 15 of the optical tape 14 during read/write operations (i.e., due to depression 140).

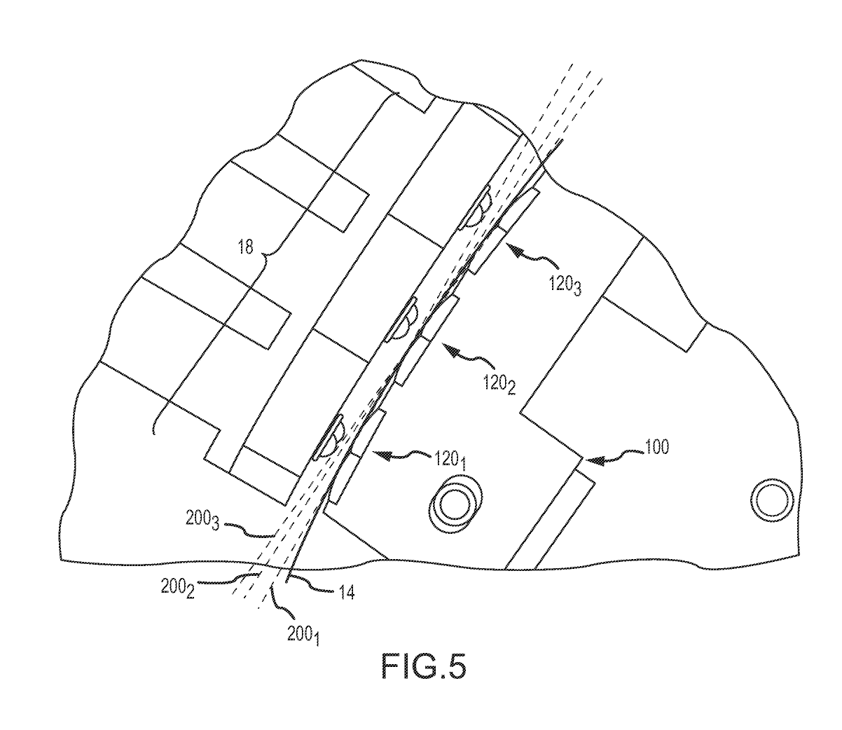

To facilitate placement of a plurality of stabilizing apparatuses 120 relative to a plurality of OPUs 18, the body 104 of the stabilizing device 100 may include a common side or surface 144 onto or into which the stabilizing apparatuses 120 may be appropriately secured. In one arrangement, the surface 144 may include a plurality of cavities 148 each being generally sized to at least partially receive a respective stabilizing apparatus 120. As just one example, the surface 144 adjacent each cavity 148 may have one or more slots or apertures (not shown) configured to receive adhesive (e.g., glue) used to secure a stabilizing apparatus 120 to the surface 144 within the cavity 148. The cavities 148 may be appropriately spaced or otherwise configured so that each stabilizing apparatus 120 may be substantially automatically aligned with one or more OPUs 18 upon securing of the stabilizing apparatus 120 within a cavity 148 (and, if necessary, securing of the body 104 to the floor 12 of the housing 11 and/or to the spacer member(s) 112). That is, the various stabilizing apparatuses 120 may be spaced over the surface 144 of the body 104 so that the respective planes 200 within which the various spans of optical tape 14 reside may be substantially perpendicular to the laser beams 30 of the respective OPUs 18. For instance, note planes 200₁, 200₂, 200₃ of respective stabilizing apparatuses 120₁, 120₂, 120₃ through which optical tape 14 travels relative to various respective OPUs 18 in FIG. 5.

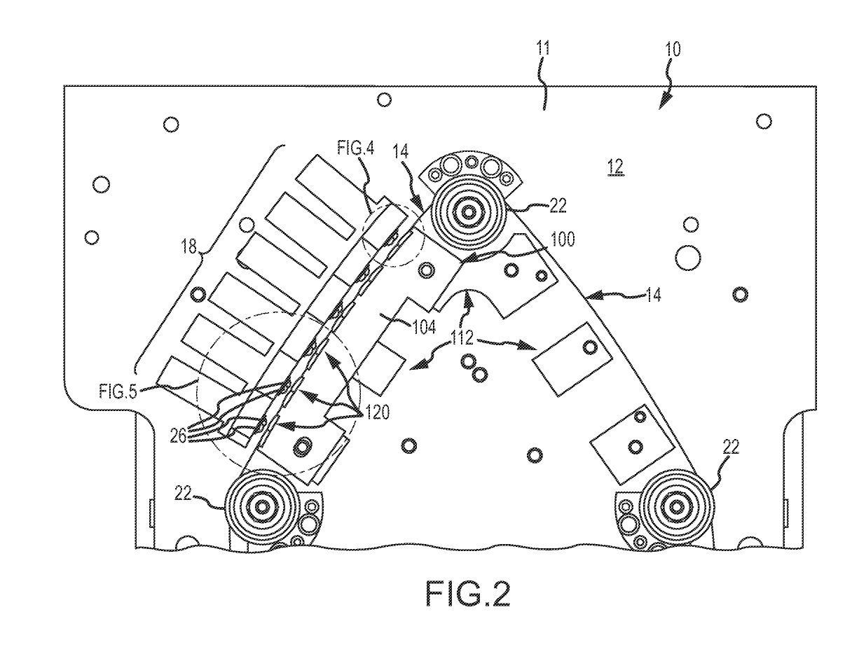

To allow the optical tape 14 to be at least partially wrapped around the first and second support portions 132, 136 of each of the plurality of stabilizing apparatuses 120, the various first and second support portions 132, 136 of the stabilizing apparatuses 120 may be appropriately positioned relative to adjacent first and second support portions 132, 136 so as to follow an overall generally convex shape towards the plurality of OPUs 18 (where the OPUs 18 may be generally positioned relative to adjacent OPUs 18 so as to follow a general concave shape towards the stabilizing apparatuses 120). See FIGS. 2 and 5. That is, an imaginary line drawn through successive first and second support portions 132, 136 of the stabilizing apparatuses 120 may have a generally convex shape towards the OPUs 18. As a result, the various planes 200₁, 200₂, 200₃ of respective stabilizing apparatuses 120₁, 120₂, 120₃ may be offset (e.g., they may be other than parallel and/or coplanar to each other). See FIG. 5.

In one arrangement, the common surface 144 of the body 104 may have an overall generally convex shape towards the OPUs 18 so that the first and second support portions 132, 136 of the identically or similarly shaped stabilizing apparatuses 120 may follow an overall generally convex shape. In another arrangement, the surface 144 of the body 104 may have an overall generally planar shape while the various stabilizing apparatuses 120 may be differently manufactured (e.g., different thicknesses and/or widths) so that the first and second support portions 132, 136 of the identically or similarly shaped stabilizing apparatuses 120 may follow an overall generally convex shape. Furthermore, while the stabilizing device 100 has been shown and discussed as including a plurality of separate pieces secured together (e.g., the body 104, the various stabilizing apparatuses 120, and the like), it is envisioned that at least some portions of the stabilizing device 100 may be formed from or as a single piece of material. For instance, the various stabilizing apparatuses 120 may be formed as a single piece that may be secured onto the surface 144 of the body 104 (where the single piece includes one or more pairs of first and second support portions 132, 136 having depressions 140 therebetween).

It will be readily appreciated that many additions and/or deviations may be made from the specific embodiments disclosed in the specification without departing from the spirit and scope of the invention. For instance, one or more additional stabilizing devices 100 having any appropriate number of stabilizing apparatuses 120 may be secured within the housing 11 to stabilize the optical tape 14 relative to additional OPUs 18 as appropriate. Furthermore, some embodiments envision that the stabilizing device 100 merely includes one or more stabilizing apparatuses 120 (i.e., it does not include the body 104). In any event, the illustrations and discussion herein have only been provided to assist the reader in understanding the various aspects of the present disclosure. Furthermore, one or more various combinations of the above discussed arrangements and embodiments are also envisioned.

While this disclosure contains many specifics, these should not be construed as limitations on the scope of the disclosure or of what may be claimed, but rather as descriptions of features specific to particular embodiments of the disclosure. Furthermore, certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. The above described embodiments including the preferred embodiment and the best mode of the invention known to the inventor at the time of filing are given by illustrative examples only.

We claim:

1. A tape drive, comprising:
a housing;
at least a first optical pickup unit (OPU) secured within the housing and configured to emit at least one laser beam along a first axis for use in performing reading and/or writing operations on optical tape moved in front of the first OPU; and
at least a first stabilizing apparatus secured within the housing and spaced from the first OPU, wherein the first stabilizing apparatus comprises first and second stabilizing members, wherein each of the first and second stabilizing members comprises a support portion configured to abuttingly support the optical tape as it is being moved in front of the first OPU, wherein the support portions of the first and second stabilizing members are separated by a recess along a tape path of the optical tape over which the optical tape passes as the optical tape moves over the support portions of the first and second stabilizing members, and wherein the first OPU is configured perform reading and/or writing operations on the optical tape over the recess as the optical tape travels along the tape path such that the first axis intersects the optical tape between the first and second support portions.

2. The tape drive of claim 1, wherein each of the first and second stabilizing members comprises a convex surface that generally faces the first OPU, and wherein the respective support portions comprise a portion of the convex surface.

3. The tape drive of claim 2, wherein each respective support portion comprises a crown of a respective convex surface.

4. The tape drive of claim 1, wherein the support portions of the first and second stabilizing members lie in a common plane, and wherein the first axis is substantially perpendicular to the common plane.

5. The tape drive of claim 1, further comprising:
first and second guide rollers secured within the housing and over which the optical tape is configured to be moved, wherein the first stabilizing apparatus is disposed between the first and second guide rollers.

6. The tape drive of claim 1, wherein the first the first axis is configured to intersect the optical tape at a first location over the recess, and further comprising:
a second OPU secured within the housing and configured to emit laser beams along a second axis for use in performing reading and/or writing operations on the optical tape as it is moved in front of the second OPU, wherein the second axis is configured to intersect the optical tape at a second location over the recess, and wherein the second location is spaced from the first location.

7. The tape drive of claim 6, wherein the first axis is substantially parallel to the second axis.

8. The tape drive of claim 1, further comprising:
a second OPU secured within the housing and configured to emit laser beams along a second axis for use in performing reading and/or writing operations on the optical tape as it is moved in front of the second OPU; and
a second stabilizing apparatus secured within the housing and spaced from the second OPU, wherein the second stabilizing apparatus comprises first and second stabilizing members, wherein each of the first and second stabilizing members comprises a support portion configured to support the optical tape as it is being moved in front of the second OPU, wherein the support portions of the first and second stabilizing members are separated by a recess over which the optical tape passes as the optical tape moves over the support portions of the first and second stabilizing members, and wherein the second axis is configured to intersect the optical tape over the recess of the second stabilizing apparatus.

9. The tape drive of claim 8, further comprising:
a stabilizing device secured within the housing, wherein the first and second stabilizing apparatuses form part of the stabilizing device.

10. The tape drive of claim 8, wherein the support portions of the first and second stabilizing members of each of the first and second stabilizing apparatuses lie in respective first and second common planes, wherein the first and second common planes are other than coplanar and parallel.

11. A method of operating an optical tape drive, comprising:
moving optical tape along a tape path over first and second support portions of at least a first stabilizing apparatus of the tape drive, wherein the first stabilizing apparatus comprises a depression between the first and second support portions over which the optical tape passes as the optical tape moves along the tape path between the first and second support portions; and
emitting, using at least a first optical pickup unit (OPU) of the tape drive, one or more laser beams onto the optical tape over the depression between the first and second support portions.

12. The method of claim 11, wherein the laser beams are emitted along at least a first axis, and wherein the first axis is substantially perpendicular to the optical tape between the first and second support portions.

13. The method of claim 11, further comprising:
emitting, using a second OPU of the tape drive, one or more laser beams along a second axis onto the optical tape over the depression between the first and second support portions, wherein the second axis is spaced from the first axis.

14. The method of claim 11, further comprising:
moving the optical tape along the tape path over first and second support portions of a plurality of additional stabilizing apparatuses of the tape drive, wherein the each of the additional stabilizing apparatuses comprises a depression between the first and second support portions over which the optical tape passes as the optical tape moves along the tape path between the first and second support portions.

15. The method of claim 14, wherein the tape path of the optical tape as it moves over the first stabilizing apparatus and the plurality of additional stabilizing apparatuses is substantially convex.

16. The method of claim 14, further comprising:
emitting, using a second OPU of the tape drive, one or more laser beams onto the optical tape over the depression between the first and second support portions of at least one of the additional stabilizing apparatuses.

17. The method of claim 14, further comprising:
moving the optical tape along the tape path over at least first and second guide rollers, wherein the first stabilizing apparatus and the plurality of additional stabilizing apparatuses are disposed along the tape path between the first and second guide rollers.

18. A device for use in stabilizing optical tape along a focus axis of at least one optical pickup unit (OPU) of an optical tape drive, the device comprising:
a base member that is configured to be secured to a housing of the optical tape drive; and
a plurality of stabilizing apparatuses secured to a common surface of the base member, wherein each stabilizing apparatus comprises first and second stabilizing members, wherein each of the first and second stabilizing members comprises a support portion configured to abuttingly support the optical tape as the optical tape is being moved within the tape drive, wherein the support portions are separated by a depression over which the optical tape passes as the optical tape travels along the tape path between.

19. The device of claim 18, wherein the common surface of the base member comprises a plurality of recesses, wherein each stabilizing apparatus is received in a respective one of the plurality of recesses.

20. The device of claim 19, wherein the plurality of stabilizing apparatuses collectively define a substantially convex tape path of the optical tape.
